(19) United States
(12) Patent Application Publication
(10) Pub. No.: US 2010/0243794 A1
(43) Pub. Date: Sep. 30, 2010

(54) FLYING APPARATUS

(75) Inventor: PHILLIP MATTHEW JERMYN, HAVANT (GB)

Correspondence Address: MCKEE, VOORHEES & SEASE, P.L.C., 801 GRAND AVENUE, SUITE 3200, DES MOINES, IA, 50309-2721, US

(73) Assignee: ALIEN TECHNOLOGIES LTD, Kowloon (HK)

(21) Appl. No.: 12/475,048

(22) Filed: May 29, 2009

(30) Foreign Application Priority Data
Mar. 24, 2009 (GB) 0905027.9

(51) Int. Cl. B64C 27/08; B64C 27/12; G01C 23/00

(52) U.S. Cl. 244/17.23; 340/975

(57) ABSTRACT

Flying apparatus is provided including a housing with two or more rotor means associated therewith. The rotor means are arranged to rotate about substantially parallel axes in use. One or more vanes are provided with said apparatus to help stabilize the apparatus in use.

### CROSS REFERENCE TO RELATED APPLICATIONS

This application claims priority from United Kingdom Application 0905027.9 filed Mar. 24, 2009, which is hereby incorporated by reference in its entirety.

### BACKGROUND OF THE INVENTION

This invention relates to flying apparatus and a method of use thereof.

Although the following description refers almost exclusively to hovering flying apparatus in the form of a toy quadcopter or quadrotor, it will be appreciated by persons skilled in the art that the present invention can relate to any suitable flying apparatus with any number of rotors, whether it be a toy or full size flying apparatus.

It is known to provide flying or hovering apparatus in the form of a quadcopter or quadrotor. This is a type of aircraft which is lifted and propelled by four sets of rotors. Control of motion of the aircraft can be achieved by varying the relative speed of each rotor to change the thrust and torque produced by each rotor.

### SUMMARY OF THE INVENTION

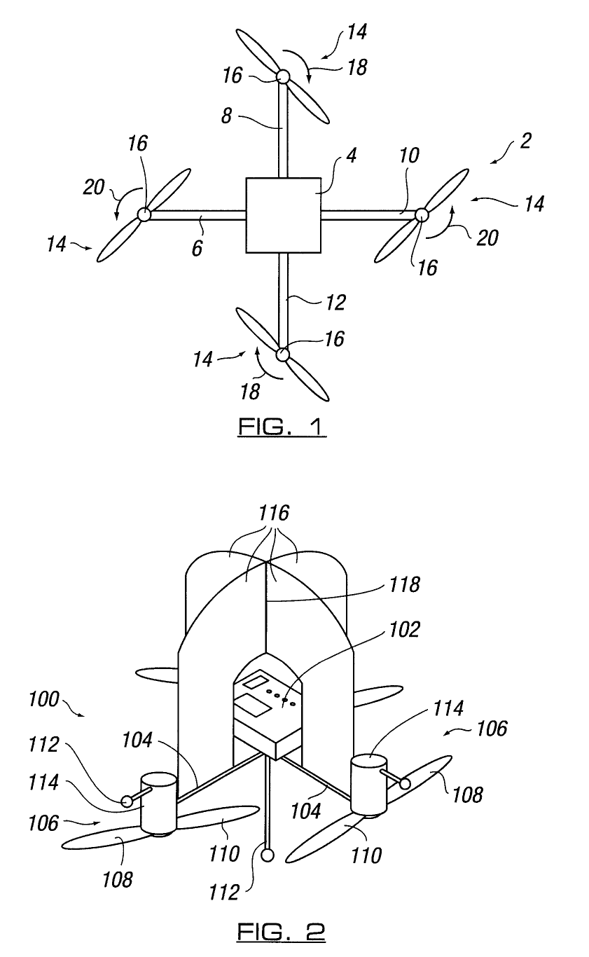

An example of a conventional quadrotor aircraft 2 is shown with reference to FIG. 1. The aircraft 2 includes a central body 4 with four elongate arms 6, 8, 10, 12 protruding outwardly therefrom to form a substantially cruciform shaped frame when viewed in plan. A rotor 14 is provided at the free end of each arm 6-12 and each rotor 14 is capable of undergoing rotational movement about a substantially vertical axis 16. Oppositely mounted rotors 14 are rotatable in the same direction and adjacently mounted rotors 14 are rotatable in opposite directions. Thus, two rotors move in a clockwise direction 18 and two rotors move in an anti-clockwise direction 20 in use of the aircraft. The torque reactions provided by driving the rotors balance, and the aircraft does not tend to spin about its central axis. Control electronics (not shown) are located in central body 4 and are typically controlled remotely via a remote control handset. A motor is associated with each rotor to allow independent control of the same.

The above described arrangement allows movement of the aircraft 2 to be controlled in three axes, by varying the speed of each rotor 14. For example, to pitch the aircraft forwards, the speed of the front rotor is reduced and the speed of the rear rotor is increased. To roll the aircraft to the right, the speed of the right rotor is reduced and the speed of the left rotor is increased. To yaw the aircraft to the right, the speed of the front and rear rotors are reduced and the speed of the left and right rotors are increased. This creates an imbalance in the torque reaction which causes the aircraft to rotate but does not create a tilt force and does not affect the overall lift of the aircraft.

Although the above described aircraft works in principle, most designs are small in size and result in rapid responses to control inputs, thereby making it difficult for a user to control. In order to overcome this problem, electronic motion sensors or gyroscopes are used to detect rotation in each of the three axes of movement (pitch, roll and yaw). These sensors provide direct negative feedback to the rotor motors to dampen the aircraft's rotational motion and help control the stability of the same. The sensors typically form part of the electronic control system mounted in the central body of the aircraft.

It is an aim of the present invention to provide flying apparatus which provides an improved level of stability.

It is a further aim of the present invention to provide a method of using flying apparatus having an improved level of stability.

According to a first aspect of the present invention there is provided flying apparatus, said apparatus including a housing with two or more rotor means associated therewith, said rotor means arranged to rotate about substantially parallel axes in use and wherein one or more vanes are provided with said apparatus to help stabilize the apparatus in use.

The one or more vanes perform two main stabilizing functions; firstly they provide drag to prevent tilt of the apparatus and secondly the drag provides damping against oscillation movement of the apparatus.

Preferably the two or more rotor means are located a spaced distance apart and arranged so as to balance the apparatus in use. For example, each rotor means can be located equal spaced distances apart from each other. The rotor means are preferably located in substantially the same vertical position with respect to the apparatus.

Preferably the two or more rotor means are arranged a pre-determined radial distance from a central body or point of said apparatus. The pre-determined radial distance is preferably substantially the same for each rotor means.

Preferably the two or more rotor means are located on or associated with a frame of said apparatus. Further preferably each rotor is located at or adjacent a peripheral edge or corner of said frame.

In one embodiment the frame is in the form of a cruciform shape when viewed in plan. For example, a plurality of elongate arms can protrude outwardly from a central body or point and rotor means can be provided at or adjacent a free end of each of said elongate arms.

In one embodiment the frame is in the form of a square shape when viewed in plan and each rotor means can be provided at or adjacent a corner of said frame.

Preferably the frame means are substantially rigid in form.

In one embodiment the apparatus includes at least three rotor means and in a preferred embodiment the apparatus includes four rotor means.

Preferably each rotor means is rotatable about a substantially vertical axis in use.

Preferably each rotor means includes two or more rotor blades and preferably said rotor blades are arranged to rotate about a substantially vertical axis.

Preferably the one or more vanes are located above, and preferably a spaced distance above the rotor means of the apparatus.

Preferably the number of vanes provided on the apparatus equals the number of rotor means provided on said apparatus.

In one embodiment the vanes are orientated substantially parallel to the frame members associated with each of the rotor means.

Preferably each vane is substantially flat or in a sheet like form. The vane is arranged in a substantially vertical plane or in a plane substantially parallel to the axis about which said rotor means rotate in use.

In one embodiment each vane has a first end which is joined to or adjacent a first end of a further vane, and a second free end.

In one embodiment the first ends of each vane are located at or adjacent a substantially central axis of the apparatus and protrude outwardly or radially from said central axis.

In one embodiment each vane spans substantially the entire diameter of the apparatus, housing or frame. If two or more vanes are provided, the vanes are typically arranged to be substantially equal distance apart from each other or in such orientation to allow balancing of the apparatus in use. For example, two vanes can be used which slot together to form a cruciform shape when viewed in plan. One or more slits or slots can be defined in the vanes to allow slotting of the same together.

The size, shape and/or height of the one or more vanes can be adjusted to alter the stability of the apparatus as required.

The vanes can be integrally formed, attached or detachably attached to the apparatus, frame or housing. The attachment means for allowing the attachment or detachable attachment of the one or more vanes include any or any combination of adhesive, welding, one or more clips, slots, hook and loop fastening, screws, inter-engaging means, friction fit and/or the like.

Preferably control means are contained in, provided on or associated with the housing. The control means allow control of the rotor means and preferably the rotor means are each independently controlled via the control means.

Preferably the flying apparatus is controlled remotely via remote control means, such as for example by a remote controlled handset operable by a user. The control means can communicate with the remote controlled handset via infra red, radio frequency and/or the like. Suitable transmitter and/or receiving means can be associated with the apparatus and/or the remote controlled handset as required to allow control signals to be passed between the handset and the flying apparatus.

Preferably the control means includes one or more motion sensors. Yet further preferably the motion sensors are capable of detecting pitch, roll and/or yaw of the apparatus.

In one embodiment of the present invention the rotor means are located at or adjacent a base of the apparatus or below said housing.

In one embodiment one or more support feet can be provided on or associated with a base of said apparatus, frame or housing to support the apparatus when on a surface, such as for example in an “out of use” position. The support feet typically protrude below the rotor means.

In one embodiment one or more wheels, rollers or other suitable movement means are provided at or adjacent the base of the apparatus to allow the apparatus to be moved across a surface, such as a ground or floor surface in use.

Preferably the flying apparatus is in the form of a hovering or non-spinning apparatus and yet further preferably the flying apparatus is in the form of a toy for use by a child or adult.

Preferably the flying apparatus is in the form of a quadrotor.

Preferably suitable drive means are provided to allow driving of the rotation of the rotor means. The drive means can include a motor, suitable gearing and/or the like.

Preferably power means are provided to allow powering of the drive means. The power means can include a mains power supply, battery power, rechargeable battery power and/or the like.

The two or more rotor means can be arranged in substantially the same horizontal plane, in an adjacent or side by side manner or can be arranged in a stacked manner, such as coaxially, with one rotor means located above or below a further rotor means.

According to a second aspect of the present invention there is provided a method of using flying apparatus, said apparatus including a housing with two or more rotor means associated therewith, said method including the step of rotating said rotor means about substantially parallel axes and wherein one or more vanes are provided with said apparatus to help stabilize the apparatus in use.

According to further aspects of the present invention there is provided a quadrotor and a method of using a quadrotor.

### BRIEF DESCRIPTION OF THE INVENTION

An embodiment of the present invention will now be described with reference to the following figures, wherein:

FIG. 1 shows an example of a prior art quadrotor aircraft in plan view;

FIG. 2 is a perspective view of a quadrotor aircraft according to an embodiment of the present invention.

### DETAILED DESCRIPTION OF THE PREFERRED EMBODIMENT

Referring to FIG. 2, there is illustrated a quadrotor 100 according to an embodiment of the present invention. The quadrotor 100 has a central body portion 102 containing electronic control means. Frame means in the form of four elongate arm members 104 protrude radially outwardly from body portion 102. Each arm member is spaced equidistance apart and is of substantially equal length. The arm members are arranged to form a substantially cruciform shape when viewed in plan from above.

Rotor means in the form of four rotors 106 are located at the free ends of each arm member 104. Each rotor 106 includes two rotary blades 108, 110 rotatable about a substantially vertical axis. A motor 114 is associated with each rotor 106 at the free end of each arm 104. The motors 114 are connected or communicate with the electronic control means provided in the central body portion 102 to allow control of the rotation of each of the rotors. The rotors 106 are operable using the control means and a remote control handset in a similar manner to the prior art device described in FIG. 1.

Support feet 112 are provided to protrude from a base of body portion 102 for supporting the quadrotor on a ground surface, such as for example a substantially horizontal surface in use.

In accordance with the present invention, there are provided four stabilizing vane members 116 to help stabilize the quadrotor in use. Each vane member 116 has a first end 118 which is attached to a first end of an adjacent vane member at a substantially central vertical axis of the apparatus, and a second end 120 which is located adjacent rotor 106 at a peripheral edge of the apparatus.

Each vane member 116 is in a sheet like form with a height substantially greater than a width thereof in the illustrated example. The vane members 116 can be any suitable shape but in the illustrated example the top section or top edge of the vane member is substantially curved or convexed in shape.

The vane members can be substantially rigid or flexible in form providing they offer some degree of stability to the apparatus.

Each vane member typically protrudes radially from a central point of the apparatus and, in the illustrated example, are substantially parallel to the frame members 104.

Four separate vane members can be provided or two vane members can be provided which span between two oppositely located rotors.

The vane members help the apparatus to be automatically self leveling in use. The vane members are located above the rotors and extend above the top of the body portion where the electronic control means are located. The vane members are thin and formed from light weight material. The vane members provide a large amount of aerodynamic drag during horizontal movement of the apparatus. For example, the vane members arranged between the front and rear of the apparatus provide drag against sideways movement of the apparatus in use. The vane members arranged between the left and right of the apparatus provide drag against fore-aft movement of the apparatus in use.

The vanes perform two main functions. Firstly, because the vanes are mounted at the top of the apparatus, the drag generated by the vanes tends to tilt the apparatus in the opposite direction to any horizontal movement undertaken by the apparatus. This provides a form of negative feedback, tending to keep the apparatus in a substantially horizontal, stationary hover. Secondly, the drag provides damping against substantially horizontal movement undertaken by the apparatus. This is important, otherwise the feedback affect from the vanes would cause the apparatus to oscillate back and forth in a pendulum type of motion. Although the two functions are provided by a pair of vanes or four vanes, the magnitude of the effect can be varied independently by changing the size of the vanes (which adjusts both effects together) and/or the height of the vanes (which alters the amount of tilt feedback but not the amount of horizontal damping).

1. Flying apparatus, said apparatus including
a housing with two or more rotor means associated therewith,
said rotor means arranged to rotate about substantially parallel axes in use and wherein one or more vanes are provided with said apparatus to help stabilize the apparatus in use.

2. Flying apparatus according to claim 1 wherein the two or more rotor means are located substantially equal spaced distances apart and are arranged so as to balance the apparatus in use.

3. Flying apparatus according to claim 1 wherein the two or more rotor means are located a pre-determined radial distance from a central body or point of said apparatus.

4. Flying apparatus according to claim 1 wherein the two or more rotor means are located on or associated with a frame of said apparatus.

5. Flying apparatus according to claim 4 wherein each of the two or more rotor means are located at or adjacent a peripheral edge or corner of said frame.

6. Flying apparatus according to claim 4 wherein the frame is in the form of a cruciform shape when viewed in plan.

7. Flying apparatus according to claim 4 wherein the frame is in the form of a square shape when viewed in plan.

8. Flying apparatus according to claim 1 wherein four rotor means are provided.

9. Flying apparatus according to claim 1 wherein each rotor means is rotatable about a substantially vertical axis in use.

10. Flying apparatus according to claim 1 wherein each rotor means includes two or more rotor blades rotatable about substantially parallel axes.

11. Flying apparatus according to claim 1 wherein the one or more vanes are provided above the rotor means of the apparatus.

12. Flying apparatus according to claim 1 wherein the number of vanes equals the number of rotor means on the apparatus.

13. Flying apparatus according to claim 4 wherein the vanes are orientated substantially parallel to the frame members of the frame associated with each of the rotor means.

14. Flying apparatus according to claim 1 wherein each vane is substantially flat or in a sheet like form.

15. Flying apparatus according to claim 1 wherein each vane has a first end joined to or adjacent a first end of a further vane, and a second end.

16. Flying apparatus according to claim 15 wherein the first ends of the vanes are located at or adjacent a substantially central axis of the apparatus and protrude outwardly or radially therefrom.

17. Flying apparatus according to claim 1 wherein each vane spans substantially the entire diameter of the apparatus or frame.

18. Flying apparatus according to claim 1 wherein a plurality of vanes are provided and the vanes are arranged substantially equal distances apart.

19. Flying apparatus according to claim 1 wherein two or more vanes are provided and are slotted together in a cruciform arrangement.

20. Flying apparatus according to claim 1 wherein the one or more vanes are attached or detachably attached to the apparatus, or a frame or housing via attachment means.

21. Flying apparatus according to claim 20 wherein the attachment means include any or any combination of one or more clips, slots, hook and loop fastening, screws, inter-engaging means, adhesive, welding, or friction fit.

22. Flying apparatus according to claim 1 wherein control means are contained in or associated with the housing, frame or apparatus for controlling each rotor means independently to the other rotor means.

23. Flying apparatus according to claim 22 wherein the control means includes one or more motion sensors capable of detecting pitch, roll and/or yaw of the apparatus.

24. Flying apparatus according to claim 1 wherein the apparatus is controlled remotely via remote control means.

25. Flying apparatus according to claim 1 wherein one or more support feet are provided on or associated with a base of the apparatus, housing or frame to support the apparatus when on a surface.

26. Flying apparatus according to claim 1 wherein one or more wheels, rollers or movement means are provided at or adjacent a base of the apparatus, housing or frame to allow the apparatus to be moved across a surface.

27. Flying apparatus according to claim 1 wherein drive means are provided to allow driving of the rotation of the rotor means in use.

28. Flying apparatus according to claim 1 wherein power means are provided to allow powering of the drive means.

29. Flying apparatus according to claim 1 wherein the apparatus is in the form of a quadrotor.

30. A method of using flying apparatus, said apparatus including
a housing with two or more rotor means associated therewith,
said method including the step of rotating said rotor means about substantially parallel axes and wherein one or more vanes are provided with said apparatus to help stabilize the apparatus in use.
